(19) United States
(12) Patent Application Publication
(10) Pub. No.: US 2003/0121494 A1
(43) Pub. Date: Jul. 3, 2003

(54) Reciprocating vane type rotary internal combustion engine (vane engine)

(76) Inventor: Ikitake Yosikane, Toride-shi (JP)

Correspondence Address: Ikitake Yosikane, 44-7, Higasi 6-chome, Toride-shi, Ibaraki, 302-0005, JP

(21) Appl. No.: 10/036,255

(22) Filed: Jan. 3, 2002

(51) Int. Cl. F02B 53/00

(52) U.S. Cl. 123/243

(57) ABSTRACT

On the reciprocating bane of a reciprocating vane type rotary internal combustion engine (vane engine), big centrifugal force is generated by a high-speed rotation and is opposed to combustion pressure, and force equal to or more than seal action force to be necessary for vanes tip is added to the case inside, and friction loss becomes big.

For get the force to support centrifugal force and to make this friction loss small, a vane tip cross-section vertical to a rotating axis is formed in a pick-shaped so as to generate gas bearing action force greatly.

In addition, in order to raise a hydrostatic pressure in neighborhood of tangent line of both the outside curved surface of vanes tip and the case inside, and to get the multiplication effect that raise a hydrodynamic pressure in the vanes tip, gas supply hole is established parallel to the rotating axis in the midsection of the vanes tip.

Therein, porous matrix or great many minute holes connect between the gas supply hole and outside curved surface of the vanes tip.

High pressure air, combustion pressure gas or steam is provided to gas supply hole, then, it is spouting out from outside curved surface of it, and get a high hydrostatic pressure and raise a hydrodynamic pressure.

Furthermore, because there is not the first steam for lubrication searing in a start, steam reservoir and pressurization pump is established. Therein, compress the air in the steam reservoir by press-fitting water in steam reservoir, then it is used to lubrication searing.

After an engine began to move in start or activation, till pressure of revitalization vapor by exhaust becomes proper, as method to get the high pressure gas for lubrication searing, part of the combustion gas which is pulled out from the second steam supply-cum-combustion gas pulling out port, which established a little to the bottom dead point from the center point of the front side vane toward rotating, this vane which combustion chamber pressure of this engine, in which continued fuel injection and combustion (make the best use of characteristic of this engine), become maximum, is connected with the first steam supply pipe for lubrication searing through a filter and a check valve.

Fuel injection in neighborhood of the top dead point is difficult to avoid the surface of a wall adhesion, because combustion chamber is so flat. As substitute for it, I devised a method to do vaporization of fuel or injection on the part which close late of air supply port near the bottom dead point, so as to vaporized or injected fuel mix with supply air without loss and so as not to join the air to pass without dropping in.

### TECHNICAL FIELD

This invention relates to improvement of a high pressure gas supply device for reciprocating vane and lubrication sealing of reciprocating vane type rotary internal combustion engine (the 961789 th Japan patent issue, Showa 42 Patent application 080957)

### BACKGROUND TECHNOLOGY

For air pollution and global warming, exhaust matter (HC, CO, NOx, blacksmoke, SO₂, CO₂) from a motor for car and industry plays big role.

So I aim at practical use of a reciprocating vane type rotary engine which has possibility to minimize the pollutant appearing from a motor and to maximize the thermal efficiency.

The possibility that a reciprocating vane type rotary engine does a pollutant in minimum is to say that, this engine is suited for a high-speed rotation (more than 12000 rpm), there is possibility to restrain forming of NOx, by the combustion and expansion process is over before the forming reaction time required of NOx passes, and separating combustion gas forcibly from a high temperature wall part, and is possibility to restrain outbreak of HC,CO and black smoke minute particle as incomplete oxidation combustion for insufficiency of oxygen and low temperature and so on, by using heat resistant ceramics as the structure materials, not cooling but keeping heat in adversely.

Furthermore, lubrication sealing of reciprocating vane and the like is done by a method of an air bearing (solid lubrication or jet cushions such as compressed air, combustion pressure gas and steam act in starting).

The exhaust revitalization steam is utilized with an exhaust turbine compressor as lubrication, sealing, inside cooling and the operation assistance.

And it becomes possible to raise thermal efficiency by dropping of the cooling loss and exhaust loss to the smallest (target efficiency more than 60%).

The reason that NSU Wankel rotary engine expected to bring a revolution to an engine was defeated, is thermal efficiency being low, for cooling area is too big to the exhaust volume, and it was fatal, though it is put to practical use and quantity of NOx outbreak is low is recognized.

As fuel of this engine, light oil, kerosene, gasoline, LNG, methanol, ethanol, hydrogen and so on is fuel of gas or liquid is possible to use. And this engine can expect small size and light weight.

Wen explain concrete enforcement example of this engine with a drawing, next is advantageous.

The structure of this engine is similar to a vane pump with FIGS. 1˜3, and in a cylinder type case (2) a column type rotor (1) turns eccentric. In this rotor (1), ditches of parallel planes (guide) is established radial equal angles degree from a central axis.

Put the reciprocating vane (4) in the guides, then, tip of reciprocating vane (4) slide while press contact in the case (2) inside by centrifugal force (consider that steam or a spring works to rear end of vane by a case).

Then, each chamber (8˜12 chamber) surrounded with two reciprocating vanes (4) of front and back next to each other, the case (2) inside, both side cases (3) and the rotor (1) outside, become to the each operation chamber.

As a change of operation chamber capacity with turn of the rotor (1), doing each process of exhaust blow off, scavenging, super charge, compression, fuel injection, combustion and expansion is 2 cycle 8˜12 cylinder engine ending all process by 1 round.

In this case, instead of fuel injection in operation chamber, air supply port (6) is divided into some parts by the partition (57) to rotary direction. The system to supply fuel by setting of fuel vaporization or injection device (58) in rear part of air supply port (in order to get rid of a loss to pass without dropping in of fuel) is thought about.

Fresh air is provided to engine from cleaner (13) through the super charger (12) and the air supply pipe (10). Exhaust gas is flow out to heat exchanger (14) from engine through the exhaust pipe (9) and the exhaust turbine (11).

Open and close point of air supply port (6) and exhaust port (5), the position and direction of fuel injection nozzle (7), glow plug (8) and the second steam supply-cum-combustion gas pulling out port (27) (for engine brake and so on) is found by the trial manufacture enforcement with various changed ways.

For NOx measure of exhaust gas, lubrication sealing and thermal efficiency improvement, I utilize steam next to show it in FIG. 3.

As a method to supply this system with water, there is one series of an atmospheric pressure water tank (29), an atmosphere opening pipe (30), a drawing valve (31), a pressure pump (32) and including squeezes electromotive valve (33), and the other series of an electromotive valve (34), pressure adjustment valve (35), vapor pressure water tank (36), an atmosphere opening valve (37), a drawing valve (38), including squeezes electromotive valve (39) and water supplying valve (40).

The former is suited for a moving devices when install it, and the latter is suited in case of fixed devices heavily in order to have a tank bring resist pressure.

Water of a water tank (29) goes through a drawing valve (31) and is pressured more than combustion pressure with a pressure pump (32), and goes through a including squeezes electromotive valve (33), enter a steam outbreak pipe (15) of a heat exchanger (14), then become steam or heating steam, and divided in prior the first steam (for lubrication sealing) series and the second steam (for operation assistance and inside cooling) series.

The first steam goes through a close delay valve (18), a check valve (19) and the first steam supply pipe (20), enter the lubrication sealing circular steam ditch (21), from which it is supplied to tip and sliding guide of reciprocating vanes (4), contact part of a rotor (1) and a side case (3), bearing part and so on.

The second steam goes through a setting pressure operation valve (22), the second steam supply pipe (23) and a check valve (24), and when changeover valve (25) open to pipe (23) and pipe (26), it enter the second steam supply-cum-combustion gas pulling out pipe (26), and from the second steam supply-cum-combustion gas pulling out port (27), it is injected to operation chamber as for operation assistance and cooling.

The first steam and the second steam except for bearing, heats itself in the engine inside and expands, and become power source with operation gas.

The pipe diverged at the first stage side of close delay valve (18) and setting pressure operation valve (22), is connected with a safety valve (16) and a pressure gauge (17).

When water supply to a steam outbreak pipe (15) by not a pressure pump (32) but pressure adjustment valve (35), pipe connected with a safety valve (16) and a pressure gauge (17) goes through an electromotive valve (34) and pressure adjustment valve (35), and connect to above in the upper part of a vapor pressure water tank (36).

The pressure adjustment valve (35) is open below setting pressure, and water of vapor pressure water tank (36) goes through a drawing valve (38) and including squeezes electromotive valve (39) by natural flowing, and flow into a steam outbreak pipe (15) of a heat exchanger (14).

When vapor pressure becomes higher than setting pressure, a pressure adjustment valve (35) closes automatically, and pressure in a vapor pressure water tank (36) becomes less relatively than the first stage side (the safety valve side) of pressure adjustment valve (35), and decreases a quantity of current from a vapor pressure water tank (36) to a steam outbreak pipe (15), then reduces steam outbreak quantity and vapor pressure.

In this case, when condensation speed of steam in the vapor pressure water tank (36) is big, elastic tank of high insulation rate that a capacity changes with water residual quantity, build in the vapor pressure water tank (36).

When changeover valve (25) open to the second steam supply-cum-combustion gas pulling out pipe (26) and combustion gas pulling out pipe (28), combustion gas in the operation chamber is pulled out from the second steam supply-cum-combustion gas pulling out port (27), through the pipe (26), changeover valve (25) and pipe (28), and bypass to an exhaust pipe (9) of the first stage side of exhaust turbine (11). Then engine brake works.

Start and activation of an engine is as following.

On the rotor, operation chamber of compression process and operation chamber of expansion process is mutually other side for the top dead point so that power for activation may be very small.

Moreover, the supply and exhaust port is after a bottom dead point, then, when the some pressure air entered all operation chamber, pressure of supply and exhaust port is lower than pressure of operation chamber opposite side from the bottom dead point.

I establish a cross divergence pipe as for start and activation in the place where a steam outbreak pipe (15) left a heat exchanger (14), and connect a vacuum destruction valve (41) to one, so that fresh air flows in if pressure in a steam outbreak pipe (15) become less than atmospheric pressure.

The other of a cross divergence pipe is connected to a ceiling of steam reservoir (42).

In addition, pressured water through a steam reservoir pressure pump (43) and pump spew valve (44) separately lay down to drawing valve (3 1) or through a steam reservoir pressure pump (47) and pump spew valve (48) separately lay down to drawing valve (38), is connected to a bottom of steam reservoir (42) through a gas flow stop valve (45) (if a counter current of water happened, and afterwards gas flowed backward, then closed) and steam reservoir pressure pipe (46).

The bottom of the steam reservoir (42) is set higher than a ceiling of water tank (29) (36), when engine has begun to move, steam reservoir pressure pump (43) (47) are stoped, and water of steam reservoir (42) comes back to the water tank (29) (36).

On cool start of engine, there is no pressure steam but atmospheric pressure air in steam reservoir (42), steam reservoir pressure pump (43) (47) inject water into bottom of steam reservoir (42) so that compress the air in it. On 0.3˜0.5 MPa, open the close delay valve (18). Then the air for lubrication sealing is supplied to sliding part and operation chamber, and rotor start rotation (compressed air or high pressure steam can be injected in operation chamber from the second steam supply-cum-combustion gas pulling out port (27), so, rotary power becomes strong, but I think that it is not necessary).

Then, fuel is injected and fire it by a glow plug, and an engine starts.

As lubrication of cool start, there is a method to do electric motor start and solid lubrication till an engine starts.

If there is pressure steam in steam reservoir (42) in warn activation, open the close delay valve (18), then rotor rotate, fuel inject, fire by glow plug, engine start activation.

Supply of gas for lubrication sealing of an engine is as follows.

On start, pressure air (also used to start of engine) of steam reservoir (42) is used to lubrication sealing, after the engine began to move in start till revitalization vapor pressure becomes combustion pressure, combustion pressure gas is used for it.

Its method is that the pipe diverges at second steam supply-cum-combustion gas pulling out pipe (26) through a filter (49), a check valve (50) and combustion pressure gas pipe (51), connect to the first steam supply pipe (20). Then, as the engine starts, part of the combustion pressure gas is used for lubrication sealing.

When revitalization vapor pressure grew than combustion pressure, revitalization steam is used for lubrication sealing, and become a routine driving state.

The lubrication sealing of sliding part of rotor and reciprocating vanes is following.

Whether succeed in a lubrication sealing by this gas or not is control life or death of this engine.

Accordingly, you must pay scrupulous attention that how make the structure of lubrication sealing.

Both bearings of a rotor (1) does it with static and dynamic pressure gas bearing structure. Contact surface of a rotor (1) with a side case (3), reciprocating vane (4) with rotor (1) guide and reciprocating vane (4) with side cases (3) is lubrication sealing structure by gas such as compressed air, combustion pressure gas and steam.

Reciprocating vane (4) is made as show FIG. 4-6, with carbon fiber textile (52) that is laminated till thickness becomes (d) with width (c), divides the tip in two by d/2, and cuts inside radius of curvature (e) to an interval of the rotor (1) radius and infinite (vertical to reciprocating face), and outside radius of curvature (f) to around ⅓ of rotor (1) radius, and vertical section to rotor axis is formed in a pick-shape.

Dent section (53) of tip which divided carbon fiber textile (52) in two is filled with broil hardening particle of graphite, silicon carbonized and so on. And gas supply hole (55) is established parallel to the rotating axis in dividing root- It is connected between the gas supply hole (55) and outside curved surface of the vanes tip, with porous matrix or great many minute holes.

For high pressure gas introduction from the lubrication sealing circular steam ditch (21), I establish a lubrication sealing ditch (56) in width side, a lubrication sealing ditch (54) in thickness side and a lubrication sealing ditch in reciprocating vane guide side of a rotor, and it is in the state that reciprocating vanes floated on high pressure gas.

On the surface of reciprocating vanes, particle of graphite, carbonization silicon and so on is penetrated and broil hardened, furthermore, coated with titanium oxide, titanium nitride, cubic boron nitride, carbonization silicon and so on, so that strengthens acid-resisting and wear-resisting.

On the tip of pick-shaped reciprocating vane, hydrodynamic pressure gas bearing force works, addition, high pressure gas jets from gas supply hole (55) to out side curved surface of the vanes tip, so that hydrostatic pressure gas bearing force is outbreak on it, and support centrifugal force to work in reciprocating vanes. This centrifugal force correspond to the maximum combustion pressure.

Thickness of vane is made as thin as possible in the extent that does not lose hardness thinly.

Because vane rotating angle for maximum compress angle is constant and continuous, so fuel injection is made continuous into (b) part of combustion chamber, and it promote to get vaporization and combustion of fuel, by charge the high voltage between a injection nozzles and glow plug.

The above is an abstract of reciprocating vane type rotary internal combustion engine. The problem is how to get possible for high speed rotation smoothly with smallest friction and leakage, and this patent is the remedy.

### DISCLOSURE OF INVENTION

The slide side between a reciprocating vane tip and case inside is maintained balance between press contact force of vane tip by centrifugal force to occur in vane itself, and resultant force of anti-power by operation chamber pressure of vane before and behind, cushion action of steam jets from vane tip, and solid lubrication or gas bearing action force in slide side.

This invention is that the lubrication of vane tip in activation makes good, and gas bearing action force by wedge action at (a) part of combustion chamber in the provided rotation is done as big as possible, prevents wear of the vane tip and case inside, and coefficient of friction is the smallest.

An equation about infinity width gas bearing,

∂p/∂x=6μU(ph−k)/ph³

A sign to use here is as follows

d, ∂: differential and partial differential coefficient

p: pressure

x: rotary direction distance in a bearing side

μ:viscosity of gas

h: clearance

U: lap speed

h₀: h where p is maximum (dp/dx=0)

k: fixed number

hₐ: gas entrance or the greatest clearance

pₐ: gas pressure in the same as above

Because if lap speed U is equal to or more than how much, I do not understand it whether I can treat it as infinity, but dp/dx is limited

With lim (U→∞) dp/dx need to (ph−k)→0. Accordingly,

Lim(U→∞)ph=k=pₐhₐ

On lap speed of 200 rotation per second by case inside diameter 250 mm

π×0.25×200=157 m/s

If I consider it to be near to infinity, when hₐ=1 mm with scavenging pressure Pₐ=0.13 MPa, at the place of the smallest clearance h₀=0.01 mm, it becomes p₀=13 MPa.

Actually, because it cannot regard U=157 m/s degree as infinity, composition force with steam cushion force and so on catches the centrifugal force of vane, but it is a purpose of this invention that is going to utilize maximum gas bearing action in that.

In addition, it needs to make centrifugal force as small as possible, but it is necessary of its degree to shut in combustion pressure.

In a liquid bearing, negative pressure do occur when go over with the narrowest part. But, in a gas bearing, if width is endlessly on super-high-speed, therefore ph=constant, then negative pressure does not occur even if go over the narrowest part.

On the basis of above-mentioned result, the vane tip is formed in a pick-shape, in order to let the maximum force show on gas bearing action, with lightening appearance specific gravity of reciprocating vane, and maintaining heat-resistant and wear-resistant.

In addition, I make static pressure raise of out side curved surface of the vanes tip, and reciprocating slide side of vanes is gas lubricated

I show the above-mentioned enforcement example with FIGS. 1 and 4˜6.

Furthermore, on start of engine, there is not the first steam of lubrication searing in steam reservoir, I establish the steam reservoir pressure pump facility. And when vapor pressure is lower than proper pressure, part of combustion gas is used for lubrication searing through a filter. I show this enforcement example with FIGS. 1˜3.

In addition, instead of injection fuel near in top dead point, vaporize or inject fuel at a position closing late of air supply port, and show enforcement example to processing the same as a gasoline engine in FIGS. 7, 8.

### BRIEF DESCRIPTION OF THE DRAWINGS

FIG. 1 is a cross section vertical to the rotor axis of the reciprocating vane type rotary engine, accommodating reciprocating vanes on this invention.

FIG. 2 is a cross section parallel with mutual opposed two vanes includes rotor axis of the same engine as above.

FIG. 3 is a figure of water system of the reciprocating vane rotary engine.

FIG. 4 is a cross section vertical to the reciprocating slide side of vane including middle line of vane depending on this invention.

FIG. 5 is a g-g cross section of FIG. 4.

FIG. 6 is figure of vane watched from vertical to the reciprocating slide side of vane.

FIG. 7 is an enlarged picture of air supply port (6).

FIG. 8 is a h-h cross section of FIG. 7.

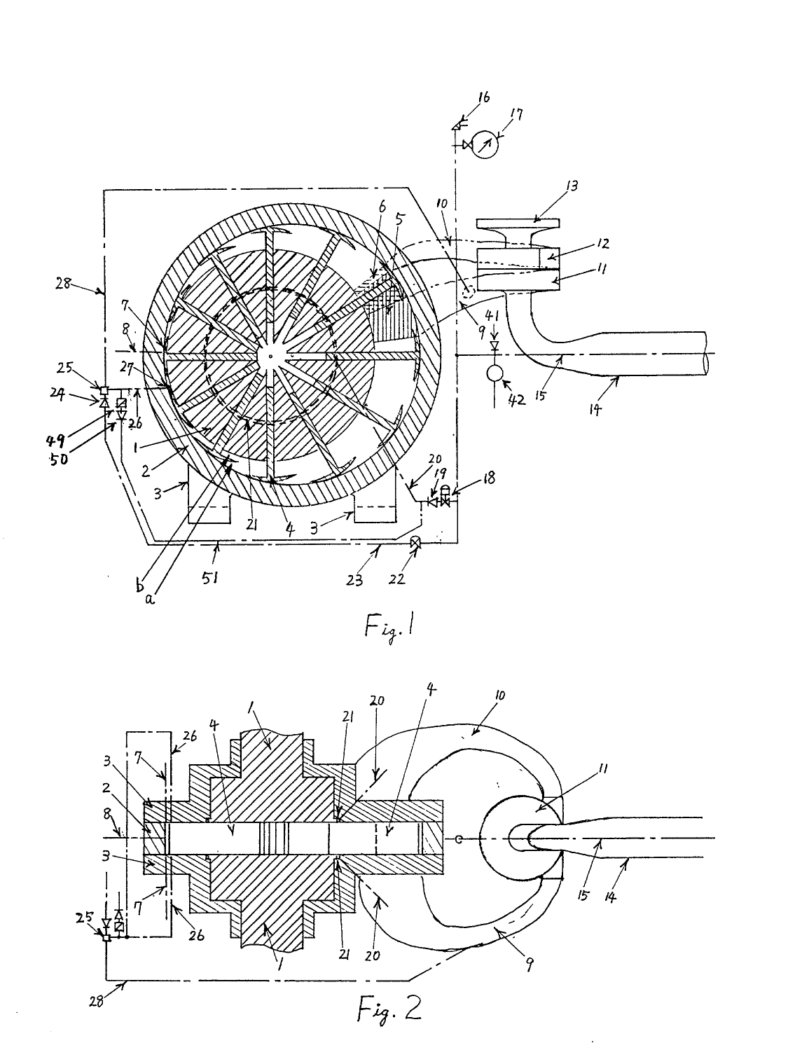

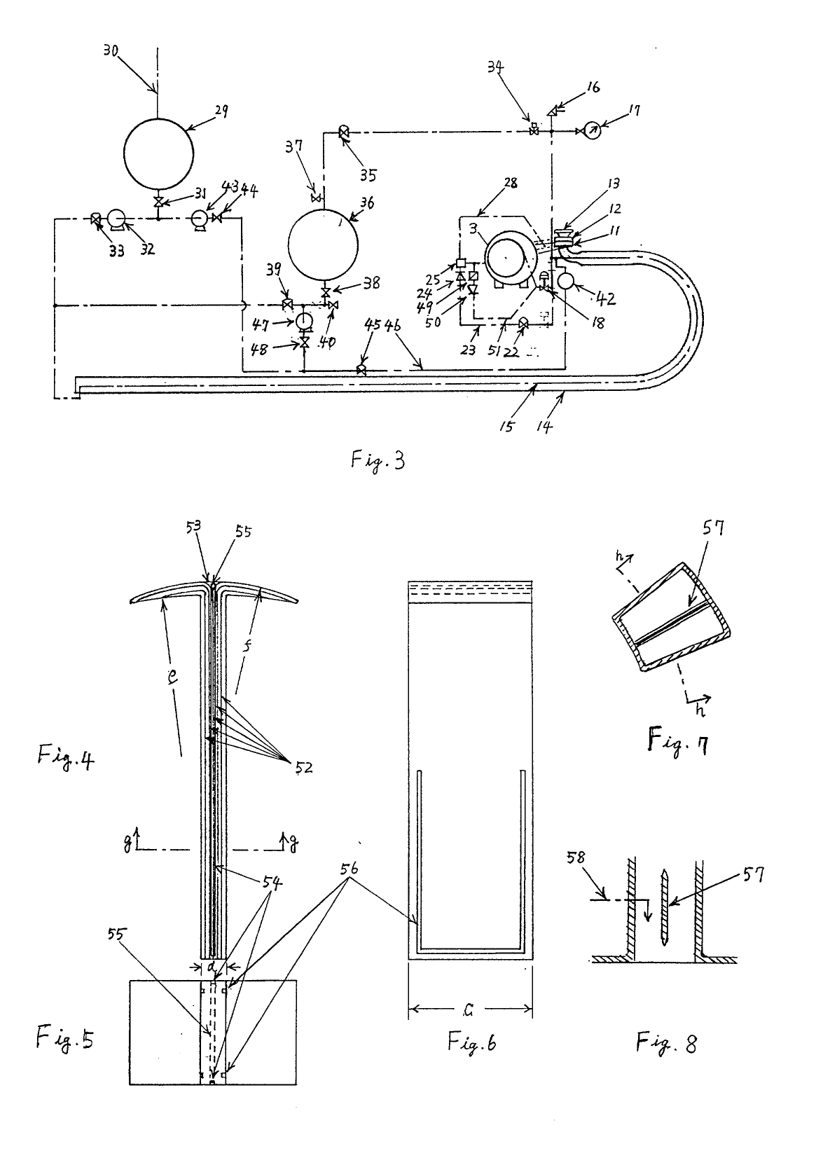

### THE BEST MODE TO CARRY OUT INVENTION

The production process of reciprocating vanes depending on this invention is explained with FIGS. 4˜6 as follows.

At first, laminating the carbon fiber textile (52) which woven from thread bundled up several thousand of carbon single fiber of marketed 10 μm size degree, till thickness becomes (d) with width (c) of vane, on intersection line of plane of half of the thickness and plane include tip lines of both guides plane on the state in top dead point, divide it in two and bend to an other side mutually at an angle of 90° around the tip line of both guide plane, and cut off tip of textile from small radius of curvature sequentially, and inside radius of curvature (e) becomes to between a rotor (1) radius and infinity, and outside radius of curvature (f) becomes into around ⅓ of rotor (1) radius, and all surface of this vane and dividing tip [symbol] section (53) is soaked and broil hardened with graphite, carbonization silicon and so on as a matrix, and the outside on it is coated with titanium oxide, titanium nitride, cubic boron nitride, carbonization silicon and so on, and finishes vane make.

There are minute cavities between internal carbon fibers innumerably by taking such a production method, and gets possible to produce high speed rotating reciprocating vane which appearance specific gravity is equal to or less than 0.8, and heat-resistant, wear-resistant and lubrication ability is highly.

To make small the appearance specific gravity of vane, methods to do lightweight are thought about while maintaining need strength such as using porous matrix or establishing a cavity part of several ratio of vane.

Use Possibility on Industry

As above, depending on this invention, pick-shaped vane and supply facility of high pressure air, combustion pressure gas and steam to vane tip, is indispensable to practical use of reciprocating vane type rotary internal combustion engine (vane engine).

Explanation of sign in a drawing.

1: rotor (united with axis)

2: case

3: side case (both sides is inequality)

4. reciprocating vane (vane)

5: exhaust port

6: air supply port

7. fuel injection nozzle

8: glow plug

9: exhaust pipe (the first side of turbine)

10: air supply pipe

11: exhaust turbine

12: supercharger

13: cleaner

14: heat exchanger (turbine second side)

15: steam outbreak pipe

16: safety valve

17: pressure gauge

18: close delay valve

19: check valve

20: the first steam supply pipe

21: lubrication sealing circular steam ditch

22: setting pressure operation valve

23: the second steam supply pipe

24: check valve

25: changeover valve

26: the second steam supply-cum-combustion gas pulling out pipe

27: the second steam supply-cum-combustion gas pulling out port

28: combustion gas pulling out pipe

29. atmospheric pressure water tank

30: atmosphere opening pipe

31: drawing valve

32: pressure pump

33: including squeezes electromotive valve

34: electromotive valve (close the time when pump (47) operate)

35: pressure adjustment valve

36: vapor pressure water tank

37: atmosphere opening valve

38: drawing valve

39: including squeezes electromotive valve

40: water supply valve

41: vacuum destruction valve

42: steam reservoir

43: steam reservoir pressure pump

44: pump spew valve

45: gas flow stop valve

46: steam reservoir pressure pipe

47: steam reservoir pressure pump

48: pump spew valve

49: filter

50: check valve

51: combustion pressure gas pipe

52: carbon fiber textile

53: dent section of tip which divided carbon

54: lubrication sealing ditch

55: gas supply hole

56: lubrication sealing ditch

57: partition

58: fuel vaporization or injection device

a: outside operation chamber of pick-shaped vane tip

b: inside operation chamber of pick-shaped vane tip

c: width of vane

d: thickness of vane

e: inside radius of curvature of pick-shaped vane tip

f: outside radius of curvature of pick-shaped vane tip

1. Cross-section of reciprocating vane of reciprocating vane type rotary internal combustion engine (vane engine), vertical to a rotating axis is formed in a pick-shaped, before and behind (for rotary direction) to the tangent line of outside curved surface of the vanes tip and case inside surface, wedge shaped gas space is prepared, then hydrodynamic pressure gas bearing force is outbreak on this vane tip by rotating it with super high speed, and support centrifugal force, and have the function of lubrication, searing and avoiding wear. The claim is the vane like it. Of course, hydrodynamic pressure gas bearing action force is in proportion to the hydrostatic pressure and becomes big, if it is raised hydrostatic pressure in outside curved surface of vane tip.

2. In order to get multiplication effect of hydrostatic pressure raise at outside curved surface of the vanes tip and hydrodynamic pressure raise owing to it, gas supply hole is established parallel to the rotating axis in the midsection of the vanes tip, and porous matrix or great many minute holes connect between the gas supply hole and outside curved surface of it. And high pressure air, combustion pressure gas or steam is provided to gas supply hole, and spouted out to outside curved surface through it, then raised the hydrostatic pressure on it. The claim is the vane like it.

3. After an engine began to move in start or activation till pressure of revitalization vapor by exhaust becomes proper, as method to get the high pressure gas for lubrication searing, part of the combustion gas which is pulled out from the second steam supply-cum-combustion gas pulling out port which established a little to the bottom dead point from the center point of the front side vane toward rotating, on its chamber point which combustion chamber pressure of this engine in which continued fuel injection and combustion, become maximum, is connected with the first steam supply pipe for lubrication searing through a filter and a check valve. The claim is the device like it.
